(19) United States
(12) Patent Application Publication
(10) Pub. No.: US 2010/0171294 A1
(43) Pub. Date: Jul. 8, 2010

(54) Occupant protecting device for vehicle and method of controlling the device

(75) Inventor: Kazuo Nomoto, Toyokawa-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/655,123

(22) Filed: Dec. 23, 2009

(30) Foreign Application Priority Data
Jan. 5, 2009 (JP) 2009-000041

(51) Int. Cl. B60R 21/16

(52) U.S. Cl. 280/735

(57) ABSTRACT

A collision detector detects a collision relative to a lateral face of a vehicle. A left seat and a right seat are arranged adjacent to each other in a left-right direction of the vehicle. A left restraint restrains an occupant seated on the left seat, and a right restraint restrains an occupant seated on the right seat. A seat position detector detects seat positions of the seats in a front-rear direction of the vehicle. A driving portion drives one of the restraints based on a direction of the collision detected by the collision detector and a relationship of the seat positions detected by the seat position detector.

### CROSS REFERENCE TO RELATED APPLICATION

This application is based on Japanese Patent Application No. 2009-000041 filed on Jan. 5, 2009, the disclosure of which is incorporated herein by reference in its entirety.

### BACKGROUND OF THE INVENTION

1. Field of the Invention

The present invention relates to an occupant protecting device for a vehicle, and a method of controlling the occupant protecting device.

2. Description of Related Art

JP-A-2002-347568 corresponding to U.S. Pat. No. 6,811,182 discloses an occupant protecting device for a vehicle. The device includes an acceleration sensor unit, a front-rear direction restraint, a left-right direction restraint and a controller unit. The acceleration sensor unit detects acceleration in a front-rear direction and a left-right direction of the vehicle. The front-rear direction restraint restrains an occupant in the front-rear direction, and the left-right direction restraint restrains an occupant in the left-right direction. The controller unit determines the vehicle to have a collision or not based on detection result of the acceleration sensor unit, and activates the restraints based on determination result, so as to protect the occupant.

The vehicle has occupant seats movable in the front-rear direction, and the seats are arranged adjacent to each other in the left-right direction. When the vehicle has a lateral side collision, an occupant seated on one of the seats may collide with adjacent occupant seated on the adjacent seat. Further, the occupant may collide with the adjacent seat. The left-right direction restraint restricts the occupant from colliding with a side face of a passenger compartment of the vehicle, but does not protect the occupant from colliding with the adjacent seat or the adjacent occupant.

### SUMMARY OF THE INVENTION

In view of the foregoing and other problems, it is an object of the present invention to provide an occupant protecting device, and a method of controlling the occupant protecting device

According to a first example of the present invention, an occupant protecting device for a vehicle includes a collision detector, a left seat, a right seat, a left restraint, a right restraint, a seat position detector and a driving portion. The collision detector detects a collision relative to a lateral face of the vehicle. The left seat and the right seat are arranged adjacent to each other in a left-right direction of the vehicle, and movable in a front-rear direction of the vehicle. The left restraint restrains an occupant seated on the left seat, and the right restraint restrains an occupant seated on the right seat. The seat position detector detects seat positions of the left and right seats in the front-rear direction. The driving portion drives one of the left and right restraints based on a direction of the collision detected by the collision detector and a relationship of the seat positions detected by the seat position detector.

Accordingly, the occupant can be protected from the collision.

According to a second example of the present invention, a method of controlling an occupant protecting device includes detecting of a collision direction relative to a lateral face of a vehicle, and detecting of a position relationship between a left seat and a right seat in a front-rear direction of the vehicle. The left seat and the right seat are arranged adjacent to each other in a left-right direction of the vehicle. The controlling method further includes driving of a restraint to restrain a first occupant seated on one of the left and right seats from colliding with the adjacent seat and a second occupant seated on the adjacent seat. The driving is performed based on the detecting of the collision direction and the detecting of the position relationship between the left seat and the right seat.

Accordingly, the occupant can be protected from the collision.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic plan view illustrating an occupant protecting device according to a first embodiment;

FIGS. 2A-2E are schematic plan views illustrating position relationships between seats of the device, when a collision impact is applied from a right side;

FIGS. 3A-3E are schematic plan views illustrating position relationships between seats of the device, when a collision impact is applied from a left side;

FIG. 4 is a schematic plan view illustrating an occupant protecting device according to a second embodiment;

FIGS. 5A-5E are schematic plan views illustrating position relationships between seats of the device, when a collision impact is applied from a right side;

FIGS. 6A-6E are schematic plan views illustrating position relationships between seats of the device, when a collision impact is applied from a left side;

FIG. 7 is a schematic plan view illustrating an occupant protecting device according to a third embodiment;

FIGS. 8A-8E are schematic plan views illustrating position relationships between seats of the device, when a collision impact is applied from a right side; and

FIGS. 9A-9E are schematic plan views illustrating position relationships between seats of the device, when a collision impact is applied from a left side.

### DETAILED DESCRIPTION OF PREFERRED EMBODIMENT

### First Embodiment

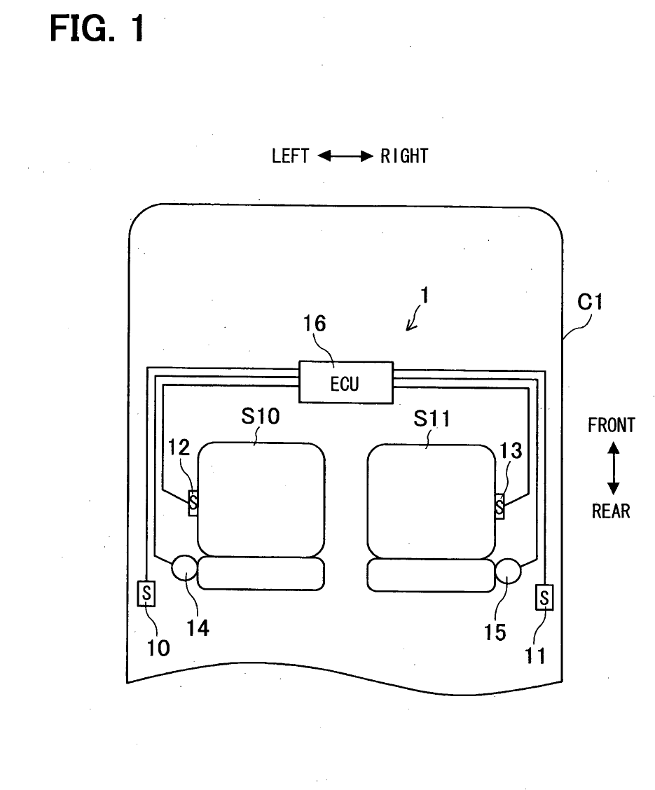

An occupant protecting device 1 shown in FIG. 1 is mounted to a vehicle C1. The device 1 detects a collision with a lateral face of the vehicle C1, and protects an occupant seated on a front seat of the vehicle C1. Specifically, the front seat corresponds to a driver seat S10 and a passenger seat S11 arranged adjacent to each other in a left-right direction of the vehicle C1. The seat S10, S11 is movable in a front-rear direction of the vehicle C1. The driver seat S10 is arranged on a left side, and the passenger seat S11 is arranged on a right side, for example.

The occupant protecting device 1 includes a side sensor 10, 11 corresponding to a collision detector, a seat position sensor 12, 13 corresponding to a seat position detector, a seatbelt pretensioner 14, 15 corresponding to a restraint, and an electronic control unit 16 (ECU) corresponding to a driving portion.

The side sensor 10, 11 detects acceleration in the left-right direction of the vehicle C1. The side sensor 10 is arranged on a left side of the vehicle C1, and is located adjacent to the driver seat S10. The side sensor 11 is arranged on a right side of the vehicle C1, and is located adjacent to the passenger seat S11.

The seat position sensor 12, 13 detects positions of the seats S10, S11 in the front-rear direction. Specifically, the seat position sensor 12, 13 detects the seats S10, S11 to be located forward or backward compared with an initial position. The seat position sensor 12 is arranged for the driver seat S10, and the seat position sensor 13 is arranged for the passenger seat S11.

The seatbelt pretensioner 14, 15 tensions a seatbelt (not shown) of the seat S10, S11, thereby occupant seated on the seat S10, S11 can be restrained. The seatbelt pretensioner 14 is arranged adjacent to the driver seat S10 on the left side of the vehicle C1, and the seatbelt pretensioner 15 is arranged adjacent to the passenger seat S11 on the right side of the vehicle C1.

The ECU 16 drives the seatbelt pretensioner 14, 15 based on detection results of the side sensor 10, 11 and the seat position sensor 12, 13. The ECU 16 determines the lateral face of the vehicle C1 to have a collision or not based on detection result of the side sensor 10, 11. Further, the ECU 16 determines a position relationship between the driver seat S10 and the passenger seat S11 based on detection result of the seat position sensor 12, 13. Furthermore, the ECU 16 activates the seatbelt pretensioner 14, 15 based on the determination results.

For example, the ECU 16 is arranged in a passenger compartment of the vehicle C1. The side sensor 10, 11, the seat position sensor 12, 13 and the seatbelt pretensioner 14, 15 are connected to the ECU 16.

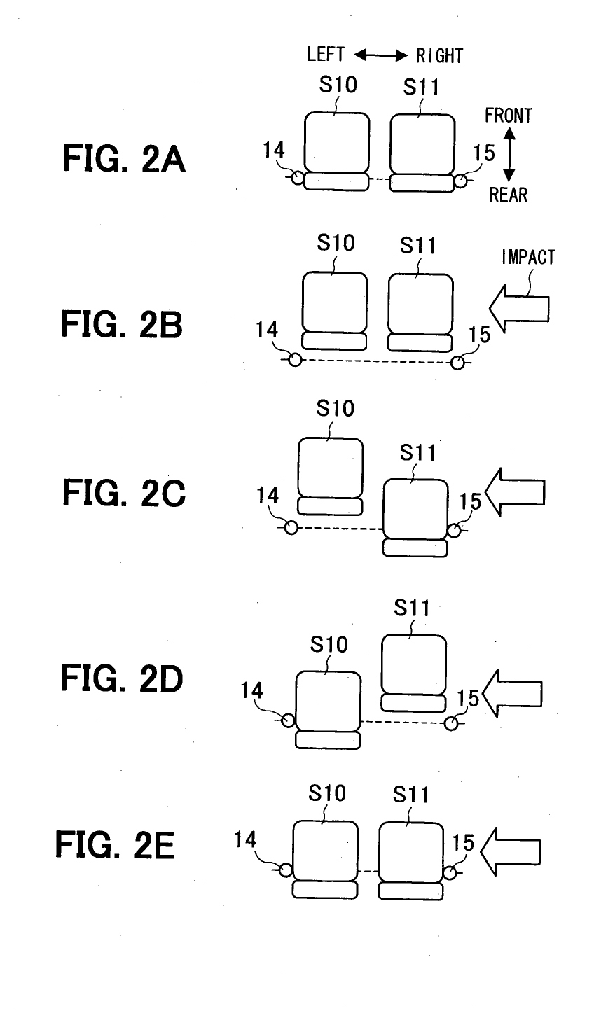

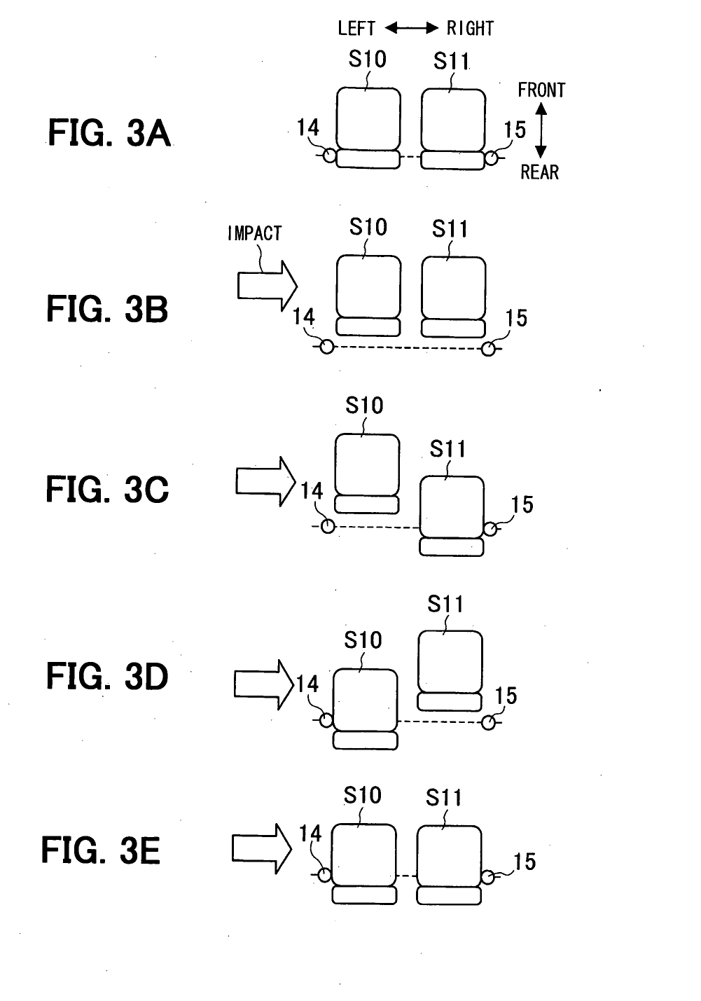

Operations of the device 1 will be described. A blank arrow of FIGS. 2B-2E and 3B-3E represents a direction of impact applied to the vehicle C1 in accordance with the collision. A broken line of FIGS. 2A-3E represents a standard line corresponding to an initial position so as to clarify the position relationship between the seats S10, S11, for convenience. FIGS. 2A and 3A represent the initial positions of the seats S10, S11.

The ECU 16 determines the vehicle C1 to have a collision or not, and determines a direction of the collision based on detection result of the side sensor 10, 11. Further, the ECU 16 determines the position relationship between the driver seat S10 and the passenger seat S11 based on detection result of the seat position sensor 12, 13.

The ECU 16 activates the seatbelt pretensioner 14, when the collision is determined to be applied from the right side relative to the vehicle C1. However, in the case that the collision is determined to be applied from the right side relative to the vehicle C1, when the driver seat S10 is determined to be located forward than the passenger seat S11, the ECU 16 does not activate the seatbelt pretensioner 14.

In contrast, when the collision is determined to be applied from the left side relative to the vehicle C1, the ECU 16 activates the seatbelt pretensioner 15 for the passenger seat S11. However, in the case that the collision is determined to be applied from the left side relative to the vehicle C1, when the passenger seat S11 is determined to be located forward than the driver seat S10, the ECU 16 does not activate the seatbelt pretensioner 15.

When the collision is applied from the right side relative to the vehicle C1, as shown in FIGS. 2B-2E, an impact is applied from the right side to the left side in accordance with the collision.

As shown in FIG. 2B, when the driver seat S10 and the passenger seat S11 are located forward than the initial position shown in FIG. 2A, a driver seated on the driver seat S10 falls on the right side, and collides with a passenger seated on the passenger seat S11.

As shown in FIG. 2C, when the driver seat S10 is located forward than the initial position, and when the passenger seat S11 is located backward than the initial position, the driver seated on the driver seat S10 falls on the right side. However, the driver seated on the driver seat S10 does not collide with the passenger seat S11 nor the passenger seated on the passenger seat S11, because the driver seat S10 is located forward than the passenger seat S11.

As shown in FIG. 2D, when the driver seat S10 is located backward than the initial position, and when the passenger seat S11 is located forward than the initial position, the driver seated on the driver seat S10 falls on the right side, and collides with the passenger seat S11.

As shown in FIG. 2E, the driver seat S10 and the passenger seat S11 are located backward than the initial position, the driver seated on the driver seat S10 falls on the right side, and collides with the passenger seated on the passenger seat S11.

That is, when the collision is applied from the right side relative to the vehicle C1, except for the case shown in FIG. 2C in which the driver seat S10 is located forward than the passenger seat S11, the driver seated on the driver seat S10 collides with the passenger seat S11 or the passenger seated on the passenger seat S11.

Therefore, in the case that the collision is determined to be applied from the right side relative to the vehicle C1, when the driver seat S10 is determined to be located equal to or backward than the passenger seat S11, the seatbelt pretensioner 14 of the driver seat S10 is activated. Thus, the driver can be prevented from colliding with the passenger seat S11 and the passenger seated on the passenger seat S11.

In contrast, when the collision is applied from the left side relative to the vehicle C1, as shown in FIGS. 3B-3E, an impact is applied from the left side to the right side in accordance with the collision.

As shown in FIG. 3B, the driver seat S10 and the passenger seat S11 are located forward than the initial position shown in FIG. 3A, the passenger seated on the passenger seat S11 falls on the left side, and collides with the driver seated on the driver seat S10.

As shown in FIG. 3C, when the driver seat S10 is located forward than the initial position, and when the passenger seat S11 is located backward than the initial position, the passenger seated on the passenger seat S11 falls on the left side, and collides with the driver seat S10.

As shown in FIG. 3D, when the driver seat S10 is located backward than the initial position, and when the passenger seat S11 is located forward than the initial position, the passenger seated on the passenger seat S11 falls on the left side. However, the passenger seated on the passenger seat S11 does not collide with the driver seat S10 nor the driver seated on the driver seat S10, because the passenger seat S11 is located forward than the driver seat S10.

As shown in FIG. 3E, the driver seat S10 and the passenger seat S11 are located backward than the initial position, the passenger seated on the passenger seat S11 falls on the left side, and collides with the driver seated on the driver seat S10.

That is, when the collision is applied from the left side relative to the vehicle C1, except for the case shown in FIG. 3D in which the passenger seat S11 is located forward than the driver seat S10, the passenger seated on the passenger seat S11 collides with the driver seat S10 or the driver seated on the driver seat S10.

Therefore, in the case that the collision is determined to be applied from the left side relative to the vehicle C1, when the passenger seat S11 is determined to be located equal to or backward than the driver seat S10, the seatbelt pretensioner 15 of the passenger seat S11 is activated. Thus, the passenger can be prevented from colliding with the driver seat S10 and the driver seated on the driver seat S10.

According to the first embodiment, when the vehicle C1 has a lateral side collision, an occupant can be restricted from colliding with an adjacent seat in the left-right direction, and can be restricted from colliding with adjacent occupant seated on the adjacent seat.

### Second Embodiment

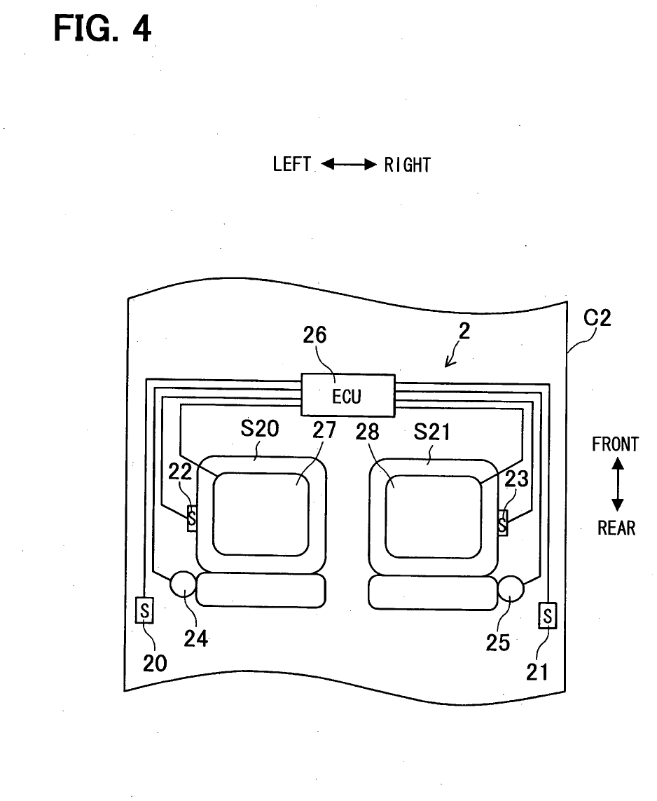

An occupant protecting device 2 shown in FIG. 4 further includes an occupant detecting sensor in a second embodiment, compared with the first embodiment. The occupant detecting sensor detects a presence or absence of occupant seated on an occupant seat. Further, condition for driving the seatbelt pretensioner is changed in the second embodiment, compared with the first embodiment.

Construction of the occupant protecting device 2 according to the second embodiment is described with reference to FIG. 4.

The occupant protecting device 2 detects a collision with a lateral face of a vehicle C2, and protects an occupant seated on a second-row seat of the vehicle C2, for example. Specifically, the second-row seat corresponds to a left seat S20 and a right seat S21 arranged adjacent to each other in a left-right direction of the vehicle C2. The seat S20, S21 is movable in a front-rear direction of the vehicle C2.

The occupant protecting device 2 includes a side sensor 20, 21 corresponding to a collision detector, a seat position sensor 22, 23 corresponding to a seat position detector, a seatbelt pretensioner 24, 25 corresponding to a restraint, and an electronic control unit 26 (ECU) corresponding to a driving portion. Further, the occupant protecting device 2 includes two of occupant detecting sensors 27, 28, which corresponds to an occupant detector. Constructions of the side sensor 20, 21, the seat position sensor 22, 23 and the seatbelt pretensioner 24, 25 are the same as those of the first embodiment.

The occupant detecting sensor 27 detects a presence or absence of left occupant seated on the left seat S20, and the occupant detecting sensor 28 detects a presence or absence of right occupant seated on the right seat S21. The occupant detecting sensor 27 is arranged on a seat face of the left seat S20, and the occupant detecting sensor 28 is arranged on a seat face of the right seat S21.

The ECU 26 drives the seatbelt pretensioner 24, 25 based on detection results of the side sensor 20, 21, the seat position sensor 22, 23 and the occupant detecting sensor 27, 28. The ECU 26 determines the lateral face of the vehicle C2 to have a collision or not based on detection result of the side sensor 20, 21. Further, the ECU 26 determines a position relationship between the left seat S20 and the right seat S21 based on detection result of the seat position sensor 22, 23. Furthermore, the ECU 26 determines a presence or absence of occupant seated on the seat S20, S21 based on detection result of the occupant detecting sensor 27, 28.

The ECU 26 activates the seatbelt pretensioner 24, 25 based on the determination results. For example, the ECU 26 is arranged in a passenger compartment of the vehicle C2. The side sensor 20, 21, the seat position sensor 22, 23, the occupant detecting sensor 27, 28 and the seatbelt pretensioner 24, 25 are connected to the ECU 26.

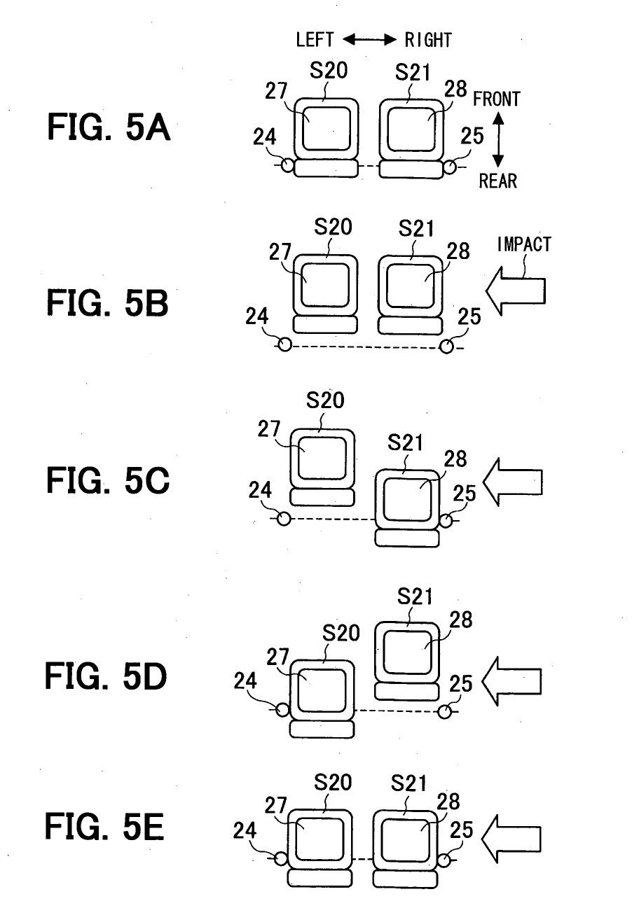

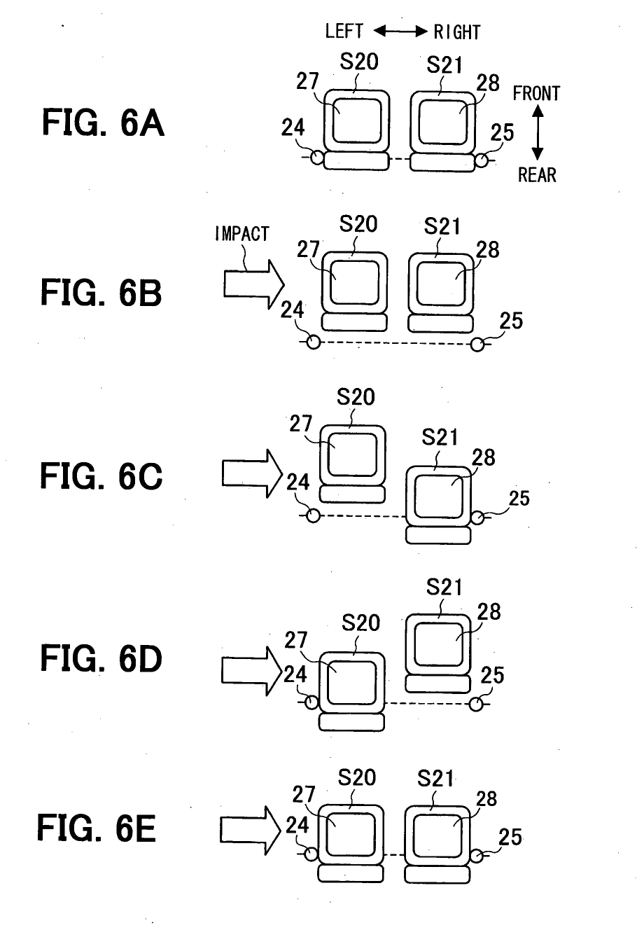

Operations of the device 2 will be described. A blank arrow of FIGS. 5B-5E and 6B-6E represents a direction of impact applied to the vehicle C2 in accordance with the collision. A broken line of FIGS. 5A-6E represents a standard line corresponding to an initial position so as to clarify the position relationship between the seats S20, S21, for convenience. FIGS. 5A and 6A represent the initial positions of the seats S20, S21.

The ECU 26 determines the vehicle C2 to have a collision or not, and determines a direction of the collision, based on detection result of the side sensor 20, 21. Further, the ECU 26 determines the position relationship between the left seat S20 and the right seat S21 based on detection result of the seat position sensor 22, 23. Furthermore, the ECU 26 determines the presence or absence of occupant seated on the seat S20, S21 based on detection result of the occupant detecting sensor 27, 28.

The ECU 26 activates the seatbelt pretensioner 24, when the collision is determined to be applied from the right side relative to the vehicle C2, and when an occupant is determined to be seated on the left seat S20. However, in the case that the collision is determined to be applied from the right side relative to the vehicle C2, when the left seat S20 is determined to be located forward than the right seat S21, the ECU 26 does not activate the seatbelt pretensioner 24.

In contrast, the ECU 26 activates the seatbelt pretensioner 25, when the collision is determined to be applied from the left side relative to the vehicle C2, and when an occupant is determined to be seated on the right seat S21. However, in the case that the collision is determined to be applied from the left side relative to the vehicle C2, when the right seat S21 is determined to be located forward than the left seat S20, the ECU 26 does not activate the seatbelt pretensioner 25.

When the collision is applied from the right side relative to the vehicle C2, except for the case shown in FIG. 5C in which the left seat S20 is located forward than the right seat S21, the occupant seated on the left seat S20 collides with the right seat S21 or the occupant seated on the right seat S21. However, when no occupant is seated on the left seat S20, the collision with the right seat S21 or the occupant seated on the right seat S21 is never generated.

Therefore, in a case that the collision is determined to be applied from the right side relative to the vehicle C2, when an occupant is determined to be seated on the left seat S20, and when the left seat S20 is determined to be located equal to or backward than the right seat S21, the seatbelt pretensioner 24 of the left seat S20 is activated. Thus, the occupant seated on the left seat S20 can be prevented from colliding with the right seat S21 or the occupant seated on the right seat S21.

In contrast, when the collision is applied from the left side relative to the vehicle C2, except for the case shown in FIG. 6D in which the right seat S21 is located forward than the left seat S20, the occupant seated on the right seat S21 collides with the left seat S20 or the occupant seated on the left seat S20. However, when no occupant is seated on the right seat S21, the collision with the left seat S20 or the occupant seated on the left seat S20 is never generated.

Therefore, in a case that the collision is determined to be applied from the left side relative to the vehicle C2, when an occupant is determined to be seated on the right seat S21, and when the right seat S21 is determined to be located equal to or backward than the left seat S20, the seatbelt pretensioner 25 of the right seat S21 is activated. Thus, the occupant seated on the right seat S21 can be prevented from colliding with the left seat S20 or the occupant seated on the left seat S20.

According to the second embodiment, when the vehicle C2 has a lateral side collision, an occupant can be restricted from colliding with an adjacent seat in the left-right direction, and can be restricted from colliding with adjacent occupant seated on the adjacent seat.

### Third Embodiment

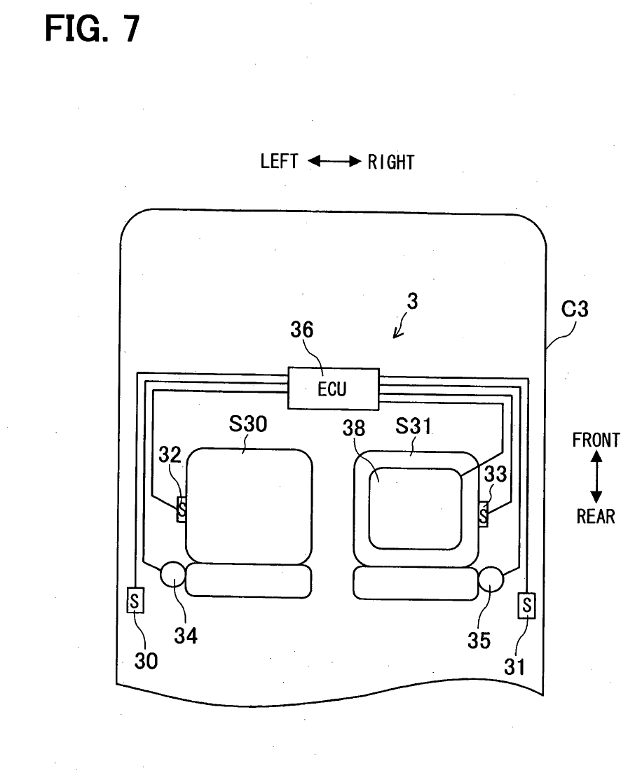

An occupant protecting device 3 shown in FIG. 7 further includes an occupant detecting sensor in a third embodiment, compared with the first embodiment. The occupant detecting sensor detects a presence or absence of passenger seated on a passenger seat. Further, condition for driving the seatbelt pretensioner is changed in the third embodiment, compared with the first embodiment.

Construction of the occupant protecting device 3 according to the third embodiment is described with reference to FIG. 7.

The occupant protecting device 3 detects a collision with a lateral face of a vehicle C3, and protects an occupant seated on a driver seat S30 and a passenger seat S31 of the vehicle C3. The occupant protecting device 3 includes a side sensor 30, 31 corresponding to a collision detector, a seat position sensor 32, 33 corresponding to a seat position detector, a seatbelt pretensioner 34, 35 corresponding to a restraint, and an electronic control unit 36 (ECU) corresponding to a driving portion.

Further, the occupant protecting device 3 includes an occupant detecting sensor 38 corresponding to an occupant detector. Constructions of the side sensor 30, 31, the seat position sensor 32, 33 and the seatbelt pretensioner 34, 35 are the same as those of the first embodiment.

The occupant detecting sensor 38 detects a presence or absence of passenger seated on the passenger seat S31. The occupant detecting sensor 38 is arranged on a seat face of the passenger seat S31.

The ECU 36 drives the seatbelt pretensioner 34, 35 based on detection results of the side sensor 30, 31, the seat position sensor 32, 33 and the occupant detecting sensor 38. The ECU 36 determines the lateral face of the vehicle C3 to have a collision or not based on detection result of the side sensor 30, 31. Further, the ECU 36 determines a position relationship between the driver seat S30 and the passenger seat S31 based on detection result of the seat position sensor 32, 33. Furthermore, the ECU 36 determines a presence or absence of passenger seated on the passenger seat S31 based on detection result of the occupant detecting sensor 38.

Because the occupant protecting device 3 is activated by the driver of the vehicle C3, the driver can be determined to be seated on the driver seat S30 by the activation of the device 3. The ECU 36 activates the seatbelt pretensioner 34, 35 based on the determination results. For example, the ECU 36 is arranged in a passenger compartment of the vehicle C3. The side sensor 30, 31, the seat position sensor 32, 33, the occupant detecting sensor 38 and the seatbelt pretensioner 34, 35 are connected to the ECU 36.

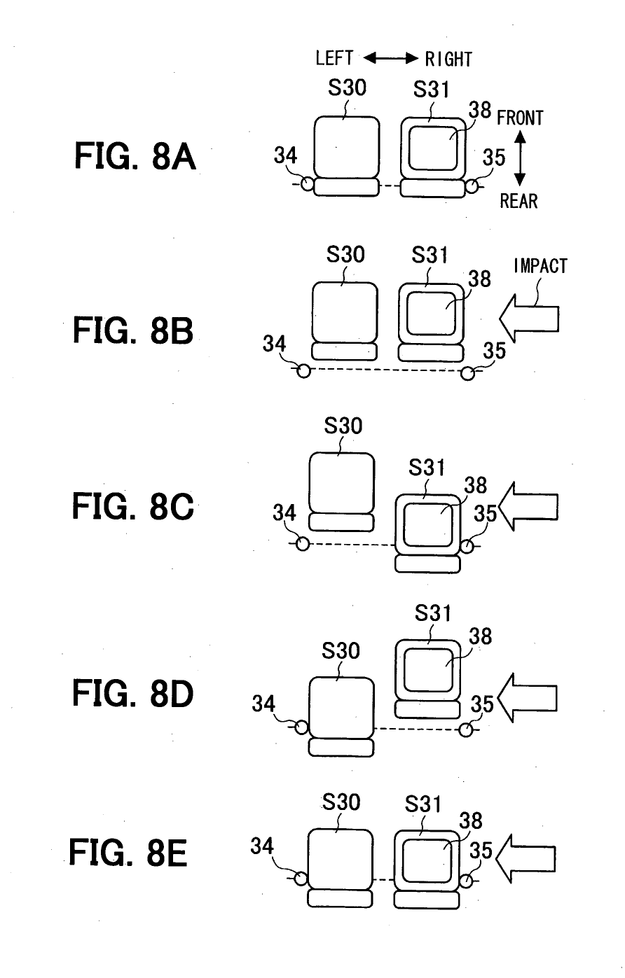

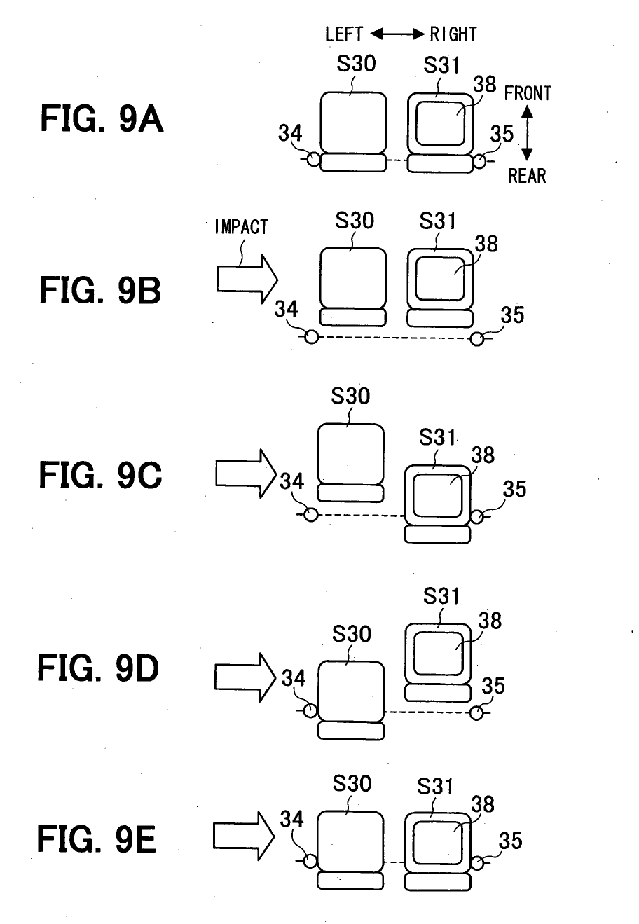

Operations of the device 3 will be described. A blank arrow of FIGS. 8B-8E and 9B-9E represents a direction of impact applied to the vehicle C3 in accordance with the collision. A broken line of FIGS. 8A-9E represents a standard line corresponding to an initial position so as to clarify the position relationship between the seats S30, S31, for convenience. FIGS. 8A and 9A represent the initial positions of the seats S30, S31.

The ECU 36 determines the vehicle C3 to have a collision or not, and determines a direction of the collision, based on detection result of the side sensor 30, 31. Further, the ECU 36 determines the position relationship between the driver seat S30 and the passenger seat S31 based on detection result of the seat position sensor 32, 33. Furthermore, the ECU 36 determines the presence or absence of passenger seated on the passenger seat S31 based on detection result of the occupant detecting sensor 38.

The ECU 36 activates the seatbelt pretensioner 34, when the collision is determined to be applied from the right side relative to the vehicle C3. However, in the case that the collision is determined to be applied from the right side relative to the vehicle C3, when the driver seat S30 is determined to be located forward than the passenger seat S31, the ECU 36 does not activate the seatbelt pretensioner 34.

In contrast, the ECU 36 activates the seatbelt pretensioner 35, when the collision is determined to be applied from the left side relative to the vehicle C3, and when the passenger is determined to be seated on the passenger seat S31. However, in the case that the collision is determined to be applied from the left side relative to the vehicle C3, when the passenger seat S31 is determined to be located forward than the driver seat S30, the ECU 36 does not activate the seatbelt pretensioner 35.

When the collision is applied from the right side relative to the vehicle C3, except for the case shown in FIG. 8C in which the driver seat S30 is located forward than the passenger seat S31, the driver seated on the driver seat S30 collides with the passenger seat S31 or the passenger seated on the passenger seat S31. When the occupant protecting device 3 is activated, the driver can be determined to be seated on the driver seat S30 by the activation of the device 3.

Therefore, in a case that the collision is determined to be applied from the right side relative to the vehicle C3, when the driver seat S30 is determined to be located equal to or backward than the passenger seat S31, the seatbelt pretensioner 34 of the driver seat S30 is activated. Thus, the driver seated on the driver seat S30 can be prevented from colliding with the passenger seat S31 or the passenger seated on the passenger seat S31.

In contrast, when the collision is applied from the left side relative to the vehicle C3, except for the case shown in FIG. 9D in which the passenger seat S31 is located forward than the driver seat S30, the passenger seated on the passenger seat S31 collides with the driver seat S30 or the driver seated on the driver seat S30. However, when no passenger is seated on the passenger seat S31, the collision with the driver seat S30 or the driver seated on the driver seat S30 is never generated.

Therefore, in a case that the collision is determined to be applied from the left side relative to the vehicle C3, when the passenger is determined to be seated on the passenger seat S31, and when the passenger seat S31 is determined to be located equal to or backward than the driver seat S30, the seatbelt pretensioner 35 of the passenger seat S31 is activated. Thus, the passenger seated on the passenger seat S31 can be prevented from colliding with the driver seat S30 or the driver seated on the driver seat S30.

According to the third embodiment, when the vehicle C3 has a lateral side collision, an occupant can be restricted from colliding with an adjacent seat in the left-right direction, and can be restricted from colliding with adjacent occupant seated on the adjacent seat.

The restraint is not limited to the seatbelt pretensioner 14, 15, 24, 25, 34, 35. Alternatively, the restraint may be a buckle pretensioner, or a seatbelt.

The seat position sensor 12, 13, 22, 23, 32, 33 is not limited to detect the seat S10, S11, S20, S21, S30, S31 to be located forward or backward relative to the initial position. Alternatively, the seat position sensor may detect more specific position of the seat. In this case, because the position relationship between of the seats adjacent to each other in the left-right direction can be more specifically determined, the condition for driving the seatbelt pretensioner 14, 15, 24, 25, 34, 35 can be more specifically set.

The number of the seats is not limited to two. Alternatively, the number of the seats may be three or more. In this case, the three or more seats are defined by plural pairs of two seats adjacent to each other in the left-right direction.

Such changes and modifications are to be understood as being within the scope of the present invention as defined by the appended claims.

What is claimed is:

1. An occupant protecting device for a vehicle comprising:
a collision detector to detect a collision relative to a lateral face of the vehicle;
a left seat and a right seat arranged adjacent to each other in a left-right direction of the vehicle, the seat being movable in a front-rear direction of the vehicle;
a left restraint to restrain an occupant seated on the left seat;
a right restraint to restrain an occupant seated on the right seat;
a seat position detector to detect seat positions of the left and right seats in the front-rear direction; and
a driving portion to drive one of the left and right restraints based on a direction of the collision detected by the collision detector and a relationship of the seat positions detected by the seat position detector.

2. The occupant protecting device according to claim 1, wherein
the driving portion drives the left restraint, when the left seat is determined to be located equal to or backward than the right seat, in a case that the vehicle is determined to have the collision from a right side, and
the driving portion drives the right restraint, when the right seat is determined to be located equal to or backward than the left seat, in a case that the vehicle is determined to have the collision from a left side.

3. The occupant protecting device according to claim 1, further comprising:
a left occupant detector to detect a presence or absence of occupant seated on the left seat; and
a right occupant detector to detect a presence or absence of occupant seated on the right seat, wherein
the driving portion drives one of the left and right restraints based on the presence or absence of occupant detected by the left occupant detector and the right occupant detector.

4. The occupant protecting device according to claim 3, wherein
the driving portion drives the left restraint, when the left occupant detector detects the presence of occupant, and when the left seat is determined to be located equal to or backward than the right seat, in a case that the vehicle is determined to have the collision from a right side, and
the driving portion drives the right restraint, when the right occupant detector detects the presence of occupant, and when the right seat is determined to be located equal to or backward than the left seat, in a case that the vehicle is determined to have the collision from a left side.

5. The occupant protecting device according to claim 1, further comprising:
a passenger detector arranged to a passenger seat defined by one of the left seat and the right seat, the passenger detector detecting a presence or absence of passenger seated on the passenger seat, wherein
the other of the left seat and the right seat is defined as a driver seat,
the passenger seat has a passenger restraint defined by corresponding one of the left restraint and the right restraint,
the driver seat has a driver restraint defined by corresponding one of the left restraint and the right restraint, and
the driving portion drives the passenger restraint based on the presence or absence of passenger detected by the passenger detector.

6. The occupant protecting device according to claim 5, wherein
the driving portion drives the driver restraint, when the driver seat is determined to be located equal to or backward than the passenger seat, in a case that the vehicle is determined to have the collision from a passenger side, and
the driving portion drives the passenger restraint, when the passenger detector detects the presence of passenger, and when the passenger seat is determined to be located equal to or backward than the driver seat, in a case that the vehicle is determined to have the collision from a driver side.

7. The occupant protecting device according to claim 1, wherein
each of the left and right restraints restrains a first occupant seated on one of the left and right seats from colliding with the adjacent seat and a second occupant seated on the adjacent seat.

8. A method of controlling an occupant protecting device comprising:
detecting a collision direction relative to a lateral face of a vehicle;
detecting a position relationship between a left seat and a right seat in a front-rear direction of the vehicle, the left seat and the right seat being arranged adjacent to each other in a left-right direction of the vehicle; and
driving a restraint to restrain a first occupant seated on one of the left and right seats from colliding with the adjacent seat and a second occupant seated on the adjacent seat, wherein
the driving is performed based on the detecting of the collision direction and the detecting of the position relationship between the left seat and the right seat.
